(19) United States
(12) Patent Application Publication
(10) Pub. No.: US 2015/0120648 A1
(43) Pub. Date: Apr. 30, 2015

(54) CONTEXT-AWARE AUGMENTED MEDIA

(71) Applicant: ZOOM INTERNATIONAL s.r.o, Prague 8 (CZ)

(72) Inventor: Vaclav Slovacek, Prague (CZ)

(73) Assignee: ZOOM INTERNATIONAL s.r.o, Prague 8 (CZ)

(21) Appl. No.: 14/252,523

(22) Filed: Apr. 14, 2014

Related U.S. Application Data
(60) Provisional application No. 61/896,068, filed on Oct. 26, 2013.

(51) Int. Cl. G06F 17/30

(52) U.S. Cl. CPC G06F 17/30289; G06F 17/30017
USPC 707/609

(57) ABSTRACT

A system for augmenting media utilizing context-based metadata, comprising a context monitoring engine that determines relevant context information and a media annotation service that annotated media content with context information, and a method for providing metadata-enhanced media content to users.

### CROSS REFERENCE TO RELATED APPLICATIONS

This application claims priority to U.S. provisional patent application Ser. No. 61/896,068, titled “CONTEXT-AWARE AUGMENTED MEDIA”, which was filed on Oct. 26, 2013, the entire specification of which is incorporated herein by reference.

### BACKGROUND OF THE INVENTION

1. Field of the Art

The disclosure relates to the field of electronic media consumption, and more particularly to the field of metadata-enhanced media.

2. Discussion of the State of the Art

Individuals in certain environments (such as, for example, contact center operations) may need or desire to review large quantities of media content, such as audio or video content. Such review may be for any of a number of reasons, such as pattern-recognition or searching for specific pieces of information (such as reviewing audio call logs for particular contact center agents, such as to score them for performance). Presently, such content must be reviewed manually in a serial manner—that is, an individual performing the review may be capable of only focusing on (viewing or listening to) a single piece of media at a time, as humans are limited in their ability to efficiently digest multiple media streams simultaneously without a potentially significant loss of focus, introducing an increased human error factor as details may be missed, as well as decreasing efficiency if media must be reviewed multiple times (such as re-listening to an audio recording because the reviewer's attention was focused elsewhere during portions of playback). This is particularly problematic when media has a greater duration than the time allotted for review, such as (continuing the previous example) a contact center agent with a regular 8-hour working shift that may be required to review many days' worth of audio call recordings.

What is needed, is a means to provide contextual clues to aid in determining what information may be relevant to review, or media's relative important with regards to a current review context (such as likelihood of a particular audio recording to contain interactions with a specified contact center agent that is being scored for call performance).

### SUMMARY OF THE INVENTION

Accordingly, the inventor has conceived and reduced to practice, in a preferred embodiment of the invention, a system for enhancing media content with associated context-based information or “metadata”, and a method for operation of such a system for providing enhanced media playback utilizing metadata.

According to a preferred embodiment of the invention, a system for enhancing media content with metadata comprising a media annotation service and a context monitoring service, is disclosed. According to the embodiment, a context monitoring service may receive or derive context-based information from a variety of sources such as an application state monitor that may provide information regarding the current state or operation of a running user application (such as, for example, providing information on what type of media is relevant, based on such factors as whether a user is operating a video player or a web browser) and that may be an integral part of a particular application (effectively, a self-reporting application) or may be a separate component that monitors running applications, a user preferences monitor that may check what configurations or settings are being made or have been stored by a user and derive any relevant context from them (such as recognizing a user's language preference, such as to provide only media in a relevant language or regional context), or a current task monitor that may track current user operations or actions, such as to provide context based on what a user is currently doing (for example, tracking a user's web browser such as via cookies as is common in the art, and deriving any context from their activity such as recognizing that a user is searching for information on a particular topic).

According to the embodiment, a media annotation service may receive context-based information as described above, and use such information annotate media content such as by directly attaching or embedding context metadata within media content (as is common in the art, such as ID3 tagging for embedding artist or album information within audio files), or by associating or linking context information with media content without altering the media itself (such as by storing context metadata in a database, and also storing a link between the metadata and media content such that whenever media content is requested any associated metadata is also made available). For example, continuing an above example, a context monitor may recognize that a user is performing a web search for information on a particular topic, and this information may be used by a media annotation service to “tag” or otherwise identify media content related to that topic, such that a user may quickly locate and review relevant media with greater efficiency than is ordinarily possible. A variety of exemplary metadata types and use cases are described below, referring to FIG. 5 in the detailed description.

According to a further preferred embodiment of the invention, a method for providing context-aware augmented media is disclosed. According to the embodiment, a user may first connect to a media annotation system. Such a connection may be either direct (such as logging into an annotation system) or indirect, such as logging into any of a variety of media review applications or services common in the art, that may be linked or otherwise operating a media annotation system according to the invention, providing such functionality to a user without requiring the user to directly interact with the annotation system. In this manner, both dedicated media annotation systems as well as integrated arrangements are possible according to the invention, allowing a variety of implementations as may be appropriate for particular uses or for providing a specific user experience.

A user may then request media for review, such as by browsing stored media or by searching for or requesting a specific media content (such as, for example, requesting a known recording by name, or searching for all recordings made on a particular date). Media may then be presented to a user, and any associated metadata may also be presented in a variety of ways according to a particular review service or applications being used (for example, a music player may have built-in tag functionality such as for displaying artist and album info of a music recording, which may be used to display any attached metadata with an audio recording being presented). In this manner, a user may quickly view not only media content but also any relevant context-based information that may aid them in determining the relevancy of such content.

According to a further embodiment of the invention, a method for generating and embedding metadata comprise the steps of retrieving a media file (such as by reading it from a database, or receiving it as it is recorded in a “live” fashion), analyzing the media such as to determine various attributes or content-based characteristics, generating (such as via a media annotation service, as described previously) metadata identifying such characteristics, embedding this new metadata within the binary structure of the media file itself, and then storing the resulting augmented media file. Additionally, an alternate method according to the invention may instead (for example) store metadata content separately from the actual media file, and instead embed links to the stored metadata within the binary structure of the media file, such that when a media file is viewed the link may be used to retrieve the stored metadata “on demand”. In this manner, metadata may be stored as an attribute of a media file, inherently becoming part of the file itself for use in any applications or services that may view or interact with media file, offering expanded functionality such as by offering the utility of metadata enhancement to external or third-party products or services, as well as making possible the use of position-based markers for metadata identifying “where” or “when” certain metadata was identified in a file, for example in contact center use cases as described below.

An additional use case for metadata-enhanced media as described herein, may be that of contact center applications. In the art, human users (such as quality review analysts or other users that may need to view or interact with media) generally need to view media (such as listening to an audio recording, or viewing a recording that includes audio and video, or audio and screen capture data, for example) in order that they may verify such content-based information as a customer's reason for calling, whether a script was followed by a contact center agent, whether a sale was made, or other such information that may be relevant to contact center operations. By utilizing context-augmented media according to the invention, it may become possible to expedite review activities as well as increase their effectiveness, for example by making such information more immediately accessible to the user. For example, a user may request a media file (for example, an audio recording of a call that took place), and be presented with an overview of the media content, such as an audio waveform or other such overview display (that may vary according to the content of a particular media file being viewed, for example a screenshot of recorded on-screen activity, or a snapshot from a video recording) along with associated metadata such as tags or embedded markers within a media file, as might be used to indicate the nature of the metadata. For example, rather than having to rewind and resume a recording from the beginning to verify whether an introduction script was followed, a user may simply look for the presence of a metadata marker near the beginning position of a file overview, and if present may view the content of the associated metadata (such as by clicking on a marker, or hovering over it with a computer input device such as a mouse, as is common practice in the art). Additionally, a user may skip irrelevant bulk in a media file by skipping from one metadata marker to another, only viewing the portions of a file that may be considered relevant to their purposes (such as points in a call where scripted items were spoken, or key phrases were uttered by a customer, or other such use cases that may be seen as relevant to contact center operations). In this manner, media files and their use in review or consumption may be greatly enhanced through the use of embedded metadata according to the invention, and in particular contact center operations may greatly benefit from increased efficiency and reliability through the ease of access to media information that may be offered.

It should be appreciated that a wide variety of specific implementations may be possible according to the invention, as the visual or functional means of presenting information to a user may vary according to many factors such as user preferences or a particular service or application being used for media review, and it should be further appreciated that such review may be performed by interaction with any appropriate media application or service that may have integrated media annotation functionality according to the invention, or that may be interacting “behind the scenes” with a media annotation system as described previously (such that functionality is provided by a system operated separately from a media review application or service, such as may be provided by a third party). Furthermore, it should be appreciated that a media annotation system may be operated independently of other services or applications as a dedicated system for user interaction, such as may be appropriate for (for example) a mobile application on a user's mobile computing device (Such as a smartphone or tablet computing device, as are common in the art and widely used for media creation and consumption). In this manner, a user may interact with a single software endpoint for a unified and convenient experience, while interacting with a variety of media creation, consumption, review, and annotation functionalities as needed.

### BRIEF DESCRIPTION OF THE DRAWING FIGURES

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram of an exemplary system architecture for enhancing media content with metadata, according to a preferred embodiment of the invention.

FIG. 6 is a method flow diagram illustrating an exemplary method for providing enhanced media content with metadata, according to a preferred embodiment of the invention.

FIG. 7 is a method flow diagram illustrating an exemplary method for generating and embedding metadata within a media file, according to an embodiment of the invention.

### DETAILED DESCRIPTION

The inventor has conceived, and reduced to practice, a system for enhancing media content with associated metadata, and a method for providing enhanced media with metadata.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### DEFINITIONS

“media content”, as used herein, may refer to any audio or visual (such as text or video) content that may be stored electronically for interaction or review by a human user. It should be appreciated that in this manner, electronic instances of non-electronic or physical media content may be utilized according to the invention (such as image-based scans of pages in a paper document), in addition to purely electronic media (such as audio recording of phone calls).

“metadata”, as used herein, may refer to any information that may be associated with media content as defined above, such as by being embedded, attached, or otherwise included with media content such that when the content is presented, any associated metadata is also presented as an integral component of the media content, or by being otherwise linked to media content without necessarily altering the content itself such as by associating a particular media content with metadata stored separately from the content (such as a metadata repository, for example an electronic database that may store metadata and links between metadata and media content).

“augmented media”, as used herein, may refer to any media content that has metadata associated with it via any of the techniques described herein, effectively media content that has been augmented with additional information for the purpose of enhancing review or consumption.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

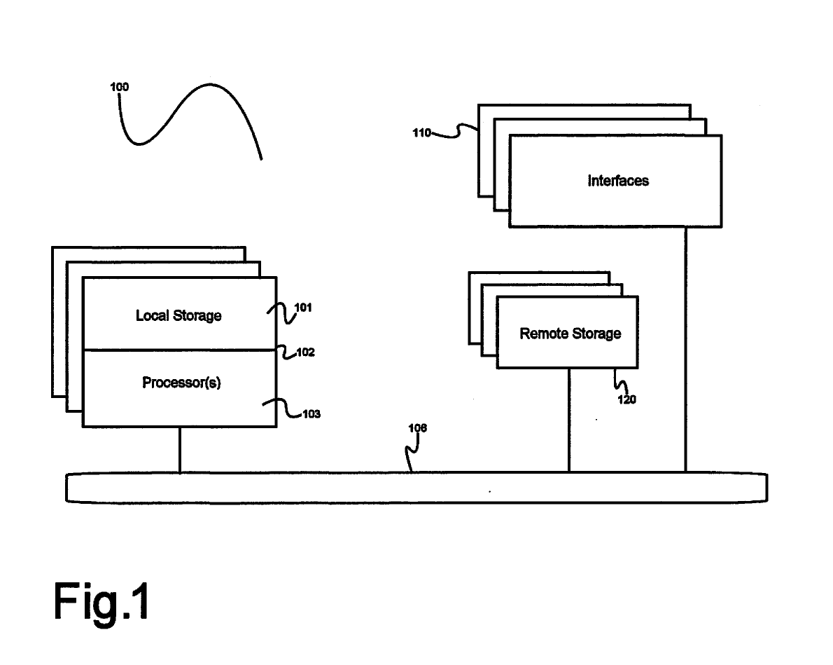

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

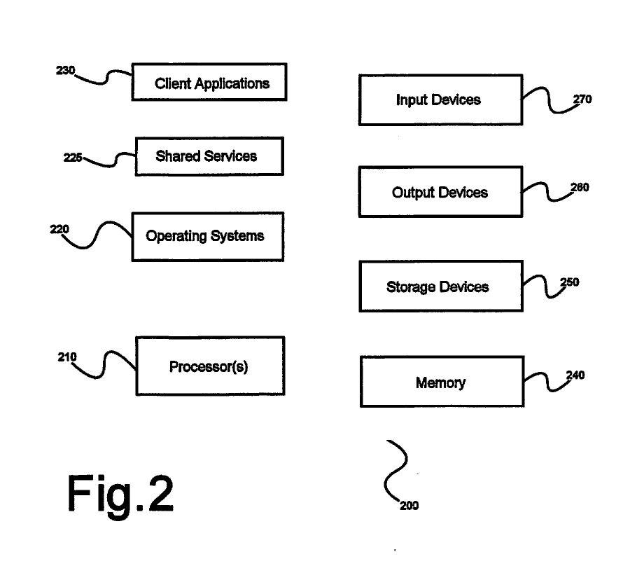

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

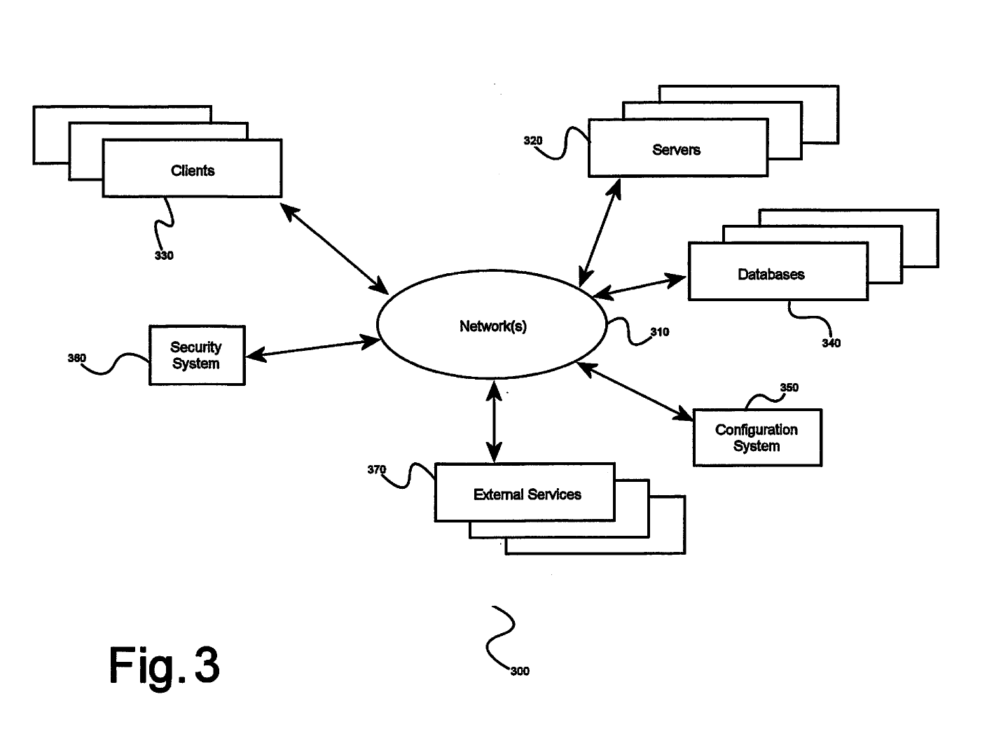

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

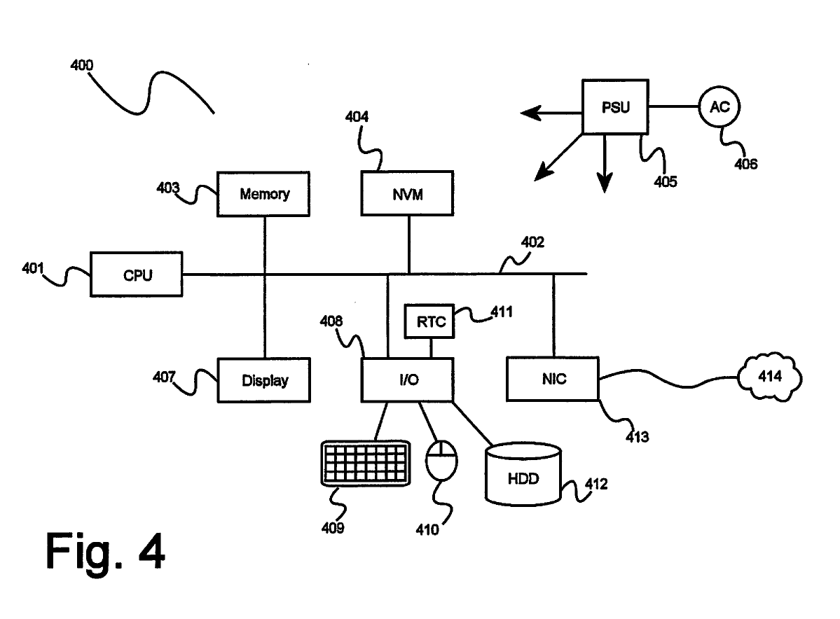

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

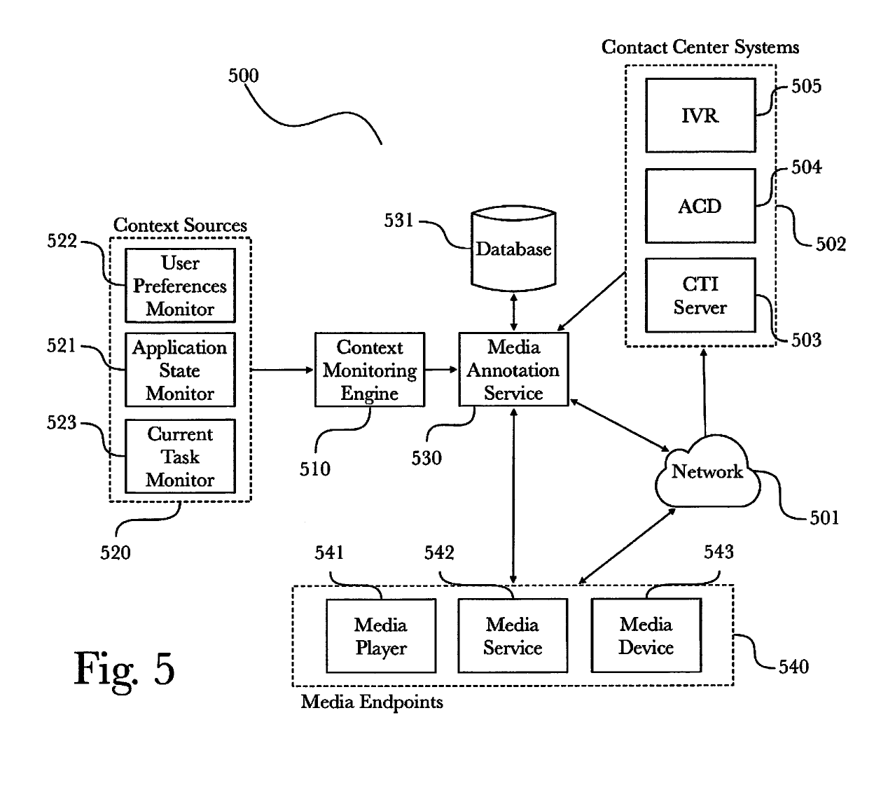

FIG. 5 is a block diagram of an exemplary system 500 for providing media annotation with context-based metadata, according to a preferred embodiment of the invention. As illustrated, a contact center 502 may comprise a variety of traditional contact center components such as a computer telephony integration (CTI) server 503, automatic call distributer (ACD) 504, or interactive voice response (IVR) system 505. These components may be connected to the Internet 501 or other appropriate communication network, such as a telephone or cellular network, such as to receive communications or other information or media. These components may then make their information (such as received communications, for example audio transmitted over a telephone connection during a phone call) to a media annotation service 530, such as to make incoming media or communications available for annotation as described below. As illustrated, media annotation service 530 may also be connected directly or indirectly (such as via a network 501) to a variety of media endpoints such as user devices, for example a media player 541 or other appropriate media service 542 or device 543, as described below.

As further illustrated, context monitoring server 510 may interact with a variety of context sources 520, such as (As illustrated) an application state monitor 521 that may provide context information based on stored or running software applications (such as what media software a user is interacting with), user preferences monitor 522 that may provide context based on a user's particular settings or configurations (such as regional preferences), or current task monitor 523 that may provide context based on the current operation or state of a user's device (such as monitoring a user's current actions on a device). It should be appreciated that context may be provided by, or received from, a variety of sources according to the invention and those illustrated and described herein are exemplary. It should be further appreciated that the function of a context monitoring service 510 may be passive (such as receiving context information from a variety of providers as described above) or active (such as querying various software or hardware elements for information rather than waiting for input from a provider) in nature, as may be appropriate according to a particular use or a particular device operating a system 500.

As further illustrated, a media annotation server 530 may be utilized, that may handle such functions as annotating media content with context-based information as may be provided by or received from a context monitoring server 510. Such annotation may be varied in mechanism, such as embedding or attaching context-based metadata directly to media content (such as is commonly used in the art for music recordings, embedding such information as artist or album information within ID3-specification or similar information tags that are an integral part of a recording file), or by linking known metadata with media content such that when media is presented any associated metadata may also be presented.

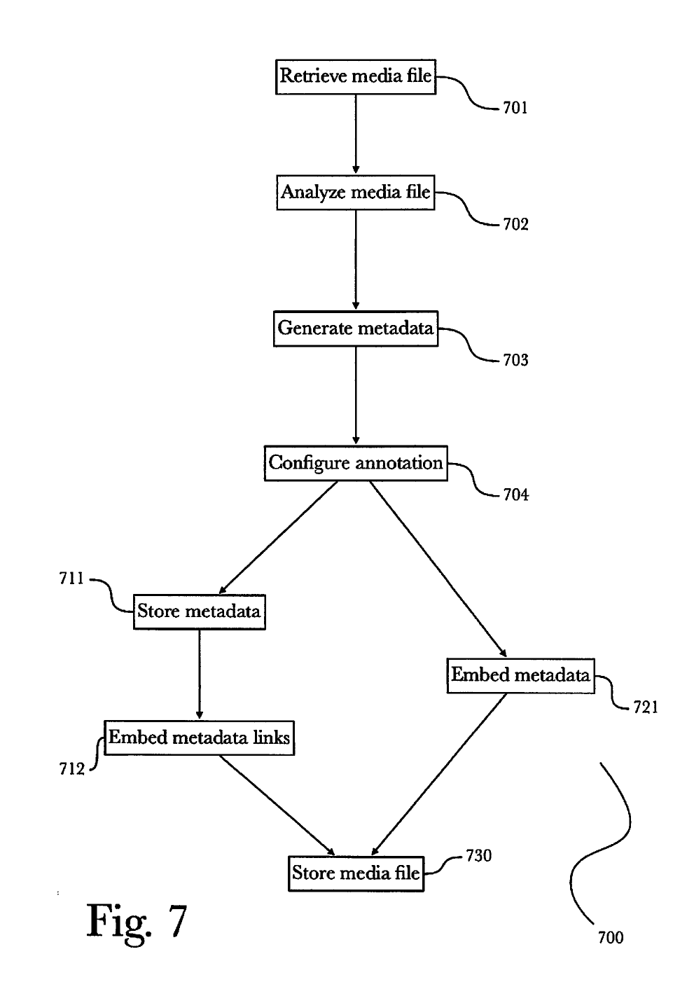

An exemplary use of embedded metadata (as described above) within a media file, may be that of a contact center review analyst. An analyst may view a media file, and in a traditional use case they would be required to view an entire file (such as listening to a full call recording, or watching an entire recording of a contact center agent's computer screen) to verify specific features or characteristics such as (for example) the reason a customer called, how an agent handled the call, whether particular quality requirements were met such as scripted phrasing elements, or other such review criteria. According to the invention, the media file may have metadata embedded within it (such as directly embedded binary data within the structure of the file, such that the metadata becomes a part of the media file itself regardless of storage or playback media, as described below referring to FIG. 7), that may enable an analyst to instead directly navigate to specific portions of a media file where metadata was identified, for example to quickly verify whether an introduction script was followed correctly, or whether a sale was made. In this manner, an analyst may perform their duties more efficiently by avoiding viewing unneeded bulk portions of a media file that might contain nothing of direct value, and instead focusing on relevant parts as identified by metadata.

As illustrated, media annotation server 530 may be connected to a database 531 or similar data storage (such as physical or electronic storage means) that may be used for storing metadata or metadata links (such as described previously), and may also be used for storing media content as appropriate. In this manner, a media annotation server 530 may be utilized for the recording, annotation, and presentation of media content and metadata to a variety of media endpoints 540. Such endpoints 540 may be any of a variety of internal (i.e., operating as a component of system 500 such as a dedicated media viewer application 541) or external (i.e., third-party or physically separated from system 500 such as network-connected software or hardware components being accessed via the Internet 501 or another communications network). Such endpoints may be software applications or services, or physical devices such as electronic or computing devices designed for media interaction (such as media content creation or consumption). Exemplary endpoints may include (but are not limited to) software-based media viewing or editing applications 541, a browser-based media service 542 (such as any of a variety of cloud-based or network-accessible services common in the art, for example PANDORA™ music streaming services), or a physical media player 543 such as a portable video device or MP3 audio player (or any suitable device for presentation or review of the desired media format). It should be appreciated that the endpoints illustrated are exemplary and any suitable media software or hardware may be utilized according to the invention, and it should be further appreciated that the connections illustrated (both direct and via the Internet 501 or another communications network) are similarly exemplary, and any means of connecting to or interacting with such endpoints may be utilized according to the invention, and furthermore that a variety of alternate or additional endpoints and connections may be utilized interchangeably or simultaneously, as may be appropriate according to a particular arrangement (such as a plurality of devices connected via a plurality of distinct communication means to a single system 500 for media interaction).

Additional functionality of a media annotation server 530 may be to augment the function of a particular endpoint (such as, for example, a media player software application that may be limited in features), such as to provide desired functions that may not ordinarily be possible. For example, not all media player devices or applications in the art may be capable of altering the speed at which media is played (i.e., “play audio at 2× speed” or “play audio at 50% speed”). Accordingly, a media annotation server 530 may be utilized to provide media playback features during the presentation of media to a particular endpoint, such that additional features may be enabled regardless of the capabilities of a particular endpoint (and thereby enabling a consistent media experience even when a user switches endpoints, for example moving from a desktop computer to a mobile device such as a smartphone). Exemplary functions that may be desirable to provide may include (as previously mentioned) altering the speed of media playback (such as to enable a user to slow down or accelerate the playback of particular media, for example slowing down a call recording when speech patterns are being analyzed or speeding it up when participants are discussing irrelevant material) or manipulation of media content during presentation (for example, “in-place” editing such that a stored or original copy of media is not altered permanently but a copy being presented may be edited as appropriate), such as inserting placeholder images, text, or audio cues to indicate sections of audio that may be skipped based on known relevancy information (such as skipping audio content from a particular speaker or regarding a particular topic, as may be based on a user's search or browsing preferences as described below with reference to metadata types and their uses), enabling a user to focus on media content that is relevant while skipping irrelevant or undesirable content without having to perform manual skipping and possibly introducing errors if they accidentally skip relevant content.

It should be appreciated that such features and their uses are exemplary, and a wide variety of additional functions and use cases may be appropriate or desirable, and may be utilized according to the invention. It should be further appreciated that any particular feature may be implemented or disabled interchangeably, for example enabling specific features based on a particular endpoint being interacted with. In this manner, a single media annotation engine 530 may offer varying configurations of features to various endpoints without needing manual configuration, by altering which features are made available based on known information about a particular endpoint being used for media presentation.

It should be noted that as illustrated, according to a particular use or arrangement of a system 500 media content may be annotated according to a variety of means such as by annotating with metadata at the time media content is created or stored (i.e., attaching contextual information at the time of recording), adding metadata to content after it has been stored (i.e., processing stored media content and augmenting with metadata, such as by a manual or batch process, for example periodically updating a media content storage to augment any new content or re-process previously-stored content for further enhancement), or at the time of presentation (i.e., using current context information such as a user's device or activity information as described previously to provide context-based information at the time that media is requested by or presented to a user). In this manner, both new and existing media may be enhanced according to the invention, and such enhancement may utilize a variety of methods or processes according to the nature of media content or an annotation operation being performed.

According to the invention, a wide variety of metadata types and uses may be utilized as may be appropriate according to the nature of data being annotated or the nature of any particular arrangement of a system 500. For example, audio-based media content such as call recordings or “podcasts” or similar audio broadcasts may be annotated with a variety of metadata intended to enhance (for example) playback, searching, or browsing interactions with such media. For example, utilizing metadata pertaining to speakers in a call or other recording, a user may be able to browse or search generally or specifically for media pertaining to particular speakers (“find all calls involving Mr. Smith”).

Utilizing additional functionalities as may be provided by external components interacting with a system 500, as described previously, for example speech-to-text analysis, additional metadata types may be utilized according to the invention. For example, using speech-to-text analysis of an audio recording, metadata may comprise a text-based full or partial transcript of a recording, enabling text-based search or other features based on the content of a recording, and a further exemplary use of transcription functionality may be the annotation of key words or phrases, such as to enable keyword-based querying of media. Utilizing optional audio analysis functionalities as may be provided by various external or third-party technologies in the art, recordings may be analyzed and annotated based on their audio qualities, such as volume level or range (as might be utilized to determine media wherein participants raise their voices, or media that has an unusually low volume and may need to be amplified prior to review), or in the case of call recordings, speech pace (as may be utilized to determine information pertaining to the pace at which participants are speaking, such as accelerated speech as a possible indicator of emotionally-charged content being discussed or slower speech indicating a lack of focus or interest). In this manner, it can be appreciated that various metadata types may be utilized interchangeably to enable desired functions to be performed with or upon particular media content, and furthermore that various additional or alternate technologies common in the art may be utilized according to the invention, such as to enable additional metadata types or to enhance function of the system of the invention.

A further feature that may be implemented via metadata annotation, is the association of metadata with a particular portion of media content, for example a portion of a single audio recording file (rather than an entire file, as is the common approach with metadata in the art, such as ID3 tags or other embedded file-based metadata that is associated with an entire media file as a whole). In this manner, any single media file may have a large quantity and variety of metadata associated with it, each instance of metadata being optionally associated only with a specific portion or subset of the media content. In this manner, by utilizing various metadata types and content, and making such metadata available to any search engine, file browser, or other content interaction software or device, media content may then be made searchable in “chunks” or sub-parts based on metadata, for example searching for a particular section of a call recording wherein a specified topic was discussed. Media content may then be optionally presented in chunks or as a whole, as may be appropriate based on known information regarding the media or metadata involved, user preference, or a selection may be presented with media results of a search, such that a user may decide how they wish media to be presented.

### DETAILED DESCRIPTION OF EXEMPLARY EMBODIMENTS

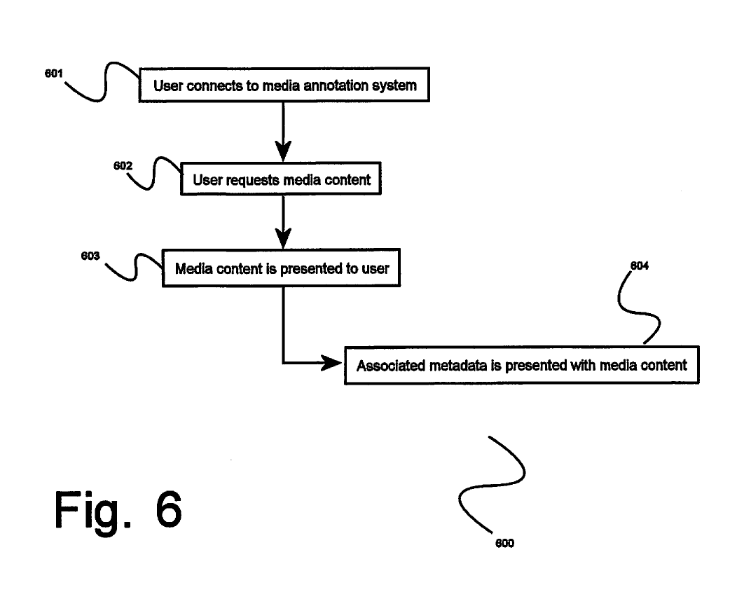

FIG. 6 is a method flow diagram illustrating an exemplary method 600 for providing metadata-enhanced augmented media content, according to a preferred embodiment of the invention. In an initial step 601, a user may connect to a media annotation system 500 such as previously described (referring to FIG. 5). Such a connection may be explicit, that is a user may choose to connect directly to a known annotation system (such as may be appropriate for a system stored or operating on a user's device, such as a media annotation application on a mobile computing device such as a smartphone or tablet computing device), or may be implicit such as a user connecting to a media playback, storage, or other relevant system such as in traditional media content creation, consumption, or review activities common in the art (such as a user connecting to a music playback system, for example a media player on a personal computing device or a cloud-based or otherwise network-connected service such as PANDORA™ Internet-based streaming media service). In this manner, a user may interact with existing devices or applications that may be familiar or convenient to them, and such devices or applications may then interact with a system 500 for augmented media on a user's behalf. In this manner, a consistent, familiar, and convenient user experience may be provided with additional utility provided according to the invention.

In a second step 602, a user may request media content. Such a request may be either explicit or passive, similar to a user connection as described above—a user may passively request media such as when browsing a media store to view available content (for example, browsing through a list of stored audio or video content on a media playback device), or may be active such as when a user searches for specific media content (such as searching for a particular audio recording by name or other information, or searching for available content according to query criteria such as specific timeframe or specific content types). In this manner, a user may interact with media in a familiar and convenient manner while still enjoying the benefits offered by media augmentation.

In a third step 603, media content may be presented to a user, such as displaying information on content as a user browses available content (as described above), or presenting a particular media content for viewing such as when a user may select media content for review (for example, selecting a particular song or video to be viewed after locating it such as via browsing a list or searching, as described above). In a next sub-step 604, metadata associated with media content may be presented to a user, such as by displaying any embedded or attached metadata that may be an integral part of media content's data (such as, as described previously, ID3 or similar information tags commonly used in the art for including relevant information such as artist or album info with music recordings), or by retrieving and presenting any known metadata that may be stored with a known link to media content being presented, as described previously (referring to FIG. 5).

In this manner, media content may be presented with metadata that is inherently a part of such content such as with audio recording that may have embedded tag information as described above, as well as being presented with associated metadata that may be stored independently from the media content itself but associated by a known link, such as in an arrangement utilizing a database to store media content or metadata interchangeably, as well as storing links between content and metadata such that they may be associated for rapid retrieval and presentation. It should also be appreciated that media content need not be limited in the quantity or means of metadata augmentation, i.e. media content may have any amount of associated metadata that may be either embedded, attached, or linked interchangeably in various combinations according to the invention. IT should be further appreciated that in this manner existing media content that may have existing metadata (such as an audio recording, for example a song, that may have previously-attached tag information) may be further augmented by the attachment, embedding, or linking of new metadata as appropriate (for example, as a result of the operation of a media annotation service 530, as described previously and referring to FIG. 5).

It should be further appreciated that, as envisioned by the inventor, media presented to a user as described above may be optionally presented in an ordered manner, such as sorted by relevancy as may be determined by metadata analysis according to the invention, or for example sorted based on time or other criteria that may be utilized in determining an ordered context for presentation. Such ordered criteria may be predetermined, such as a preconfigured set of criteria (for example, stored in a database or other data store and loaded alongside data for presentation), or it may be configurable by a user such as to allow custom-tailored sorting or other display configuration according to a particular user's preference. In this manner, data may be presented in a more orderly and useful manner to optimize consumption, and users may be optionally given a degree of control over the manner of display to further improve presentation on a per-user basis.

FIG. 7 is a method flow diagram illustrating an exemplary method 700 for generating and embedding metadata within a media file, according to an embodiment of the invention. According to the embodiment, in an initial step 701 a media file may be retrieved, such as by loading from a database or other storage medium, or by recording media as it is taking place (such as a call recording in a contact center). In a next step 702, the media file may be analyzed, for example by a context monitoring server (described above, referring to FIG. 5), such as to determine characteristics and content for the generation of appropriate metadata information. In a next step 703, metadata may be generated, such as by a media annotation server (as described above, again referring to FIG. 5). In a next step 704, annotation may be configured such as by loading a stored configuration or by manually configuring operation (such as by a human user that may be performing manual analysis and annotation of a media file, for example to enhance a collection of existing media files with metadata according to the invention), and may determine how annotation is to take place in a next step.

In a first branching step 711, metadata may be stored separately from a media file, such as in a database or other storage medium, effecting a stored collection of metadata that may be managed separately from stored media. In a next step 712, links to metadata (such as may be used to locate specific metadata from a stored collection described above) may be added to the media file, such as by incorporating them into the binary structure of the file—that is, placing the electronic data for the metadata link within the data for the media file itself in a non-destructive manner, such that the two sets of data now form a single resulting file with the properties and content of both. In this manner, metadata may be kept separate from media files (such as to manage individual file sizes, rather than increasing the size of every media file with large amounts of metadata unnecessarily), and links may be used to locate and retrieve metadata when needed, such as during viewing or other interaction with a media file.

In an alternate branching step 721, metadata information may be embedded within the binary structure of a media file, rather than storing separately and embedding only a link as described above. In this manner, metadata may be intrinsically associated (i.e., the data merged) with a corresponding media file, eliminating the possibility of invalid metadata due to (for example) deletion of stored metadata without deleting a corresponding link within a media file. Additionally, in this manner media files may retain their metadata information regardless of storage or playback medium, or of storage location (that is, links may not be invalidated due to moving either the media file or metadata information, or both), preserving the results of metadata enhancement as long as the media file remains intact.

In a final step 730, a media file (and optionally and associated metadata or metadata links, such as those not embedded within a file in a previous step) may be stored for future reference, such as in a database or physical storage medium. For example, media files may be stored and later retrieved to process according to a method 700 such as to update metadata with new information, for example to incorporate information that has been updated or to incorporate information from new metadata or context sources. In this manner, media and metadata may be kept up-to-date, either in an automated or manual fashion interchangeably according to the invention, such as part of a scheduled or otherwise automated or semi-automated process, or as a manual update operation performed by a human user such as during a review process.

The skilled person will be aware of a range of possible modifications of the various embodiments described above. Accordingly, the present invention is defined by the claims and their equivalents.

1. A system for augmentation of media content utilizing metadata, comprising:
a context monitoring server stored and operating on a network-attached computer;
a plurality of media endpoints stored and operating on network-attached computing devices;
a database stored and operating on a network-attached computer; and
a media annotation service stored and operating on a network-attached computer;
wherein the context monitoring server receives media content from a plurality of media content sources over a network and determines contextual information relevant to the media content as the media content is received;
wherein the media annotation service augments the media content with metadata based on the contextual information and stores the resulting augmented media content in the database;
wherein the media annotation service stores the media content and the metadata in the database; and
wherein the augmented media content is viewable by the media endpoints.

2. (canceled)

3. The system of claim 2, wherein the media annotation service stores information links between media content and metadata in the database.

4. (canceled)

5. The system of claim 1, wherein the context monitoring engine receives contextual information from external sources.

6. The system of claim 1, wherein the media annotation service receives media content from contact center systems.

7. The system of claim 6, wherein the contact center systems comprise an automated call distributor.

8. The system of claim 6, wherein the contact center systems comprise an interactive voice response system.

9. The system of claim 6, wherein the contact center systems comprise a computer telephony integration server.

10. A method for enhancing media content with metadata, comprising the steps of:
receiving, at a context monitoring server, a media file;
analyzing the media file to determine content-based information as the media file is received;
generating, using a media annotation server, metadata based at least in part on the content-based information;
storing the media file and the metadata in the database; and
sending the media file and the metadata to a media endpoint for simultaneous viewing.

11. (canceled)

12. The method of claim 11, further comprising the steps of:
generating, using a media annotation server, metadata links based at least in part on the stored metadata; and
embedding the metadata links within the media file.

13. The method of claim 12, wherein the embedded metadata links are incorporated into the media file's binary structure.

14. (canceled)

15. The method of claim 10, further comprising the step of embedding the metadata in the media file.

16. The method of claim 15, wherein the embedded metadata is incorporated into the media file's binary structure.

17. (canceled)
